(19) United States
(12) Patent Application Publication
(10) Pub. No.: US 2017/0052029 A1
(43) Pub. Date: Feb. 23, 2017

(54) SHIP DISPLAY DEVICE

(71) Applicant: FURUNO ELECTRIC CO., LTD., Nishinomiya City (JP)

(72) Inventors: Akira NINOMIYA, Kobe City (JP); Kentaroh HAMAMOTO, Osaka (JP)

(21) Appl. No.: 15/232,283

(22) Filed: Aug. 9, 2016

(30) Foreign Application Priority Data
Aug. 19, 2015 (JP) 2015-162034

(51) Int. Cl. G01C 21/20; G06T 11/20; G08G 3/00; G01S 19/13; H04L 29/08; G01S 13/89; G01S 15/96; G06T 11/00; G05D 1/02

(52) U.S. Cl. CPC G01C 21/203; G06T 11/001; G06T 11/203; G08G 3/00; G05D 1/0206; H04L 67/12; G01S 13/89; G01S 15/96; G01S 19/13; G06T 2207/30241; G06T 2207/20021

(57) ABSTRACT

There is provided a display device with which the density of ship traffic can be intuitively ascertained, without the display looking complicated even in areas through which ships frequently pass. This ship display device comprises a past track storage component and a display component. The past track storage component stores information related to the past tracks of ships. The display component graphically displays a track density distribution, which is a density distribution of the past tracks. More specifically, the display component displays the track density distribution with a grid divided up in regular intervals. The colors of the sections varies to change from one color to another as the density of the past tracks increases.

### CROSS-REFERENCE TO RELATED APPLICATIONS

This application claims priority to Japanese Patent Application No. 2015-162034 filed on Aug. 19,2015. The entire disclosure of Japanese Patent Application No. 2015-162034 is hereby incorporated herein by reference.

### BACKGROUND

Field of the Invention

The present invention relates to a ship display device. More particularly, relates to the configuration of a ship display device that graphically displays information related to tracks.

Background Information

A ship display device that is able to display various kinds of information related to ships was known in the past. Japanese Unexamined Patent Application Publication Nos. H7-104056 (Patent Literature 1) and 2013-134089 (Patent Literature 2) disclose this type of ship display device.

Patent Literature 1 discloses a display device with which information about the position of the host ship measured by a positioning device is written to a storage medium along with sensed information about water temperature and seafloor depth, and the track is displayed by means of the display color or contrast corresponding to the depth or water temperature information read from the storage medium.

Patent Literature 2 discloses an optimal course calculation device with which an area including the courses of ships is divided into a plurality of squares, past marine weather data in each square is subjected to statistical processing, and the optimal course from the point of departure to the destination is calculated on the basis of the statistical data that has undergone this statistical processing and ship navigation performance data.

### SUMMARY

The display device in Patent Literature 1 can store information about the track of the host ship and display this track. Nevertheless, when the amount of track information increases, the screen becomes particularly crowded with tracks and difficult to read in areas through which the ship (the host ship) passes often, and on this point there was still room for improvement.

Meanwhile, Patent Literature 2 uses the result of statistical processing as marine weather data, and does not perform any processing to make stored information about tracks easier to read.

The present invention was conceived in light of the above situation, and it is an object thereof to provide a display device with which the density of ship traffic can be intuitively ascertained, without the display looking complicated even in areas through which ships frequently pass.

The problem to be solved by the present invention is as stated above, and next the means for solving this problem, and the effect thereof, will be described.

One aspect of the present invention provides a ship display device with the following configuration. Specifically, this ship display device comprises a past track storage component and a display component. The past track storage component stores information related to past tracks of ships. The display component graphically displays a track density distribution, which is the density distribution of the past tracks.

Consequently, a geographical trend related to navigational traffic of ships can be ascertained on the basis of information about past tracks. As a result, navigational safety is improved, and this feature can be put to good use in selecting fishing sites. Also, since the tracks are displayed in the form of a density distribution, the display does not look complicated to the user.

This ship display device preferably has the following configuration. Specifically, the display component displays the track density distribution with a grid divided up in regular intervals. The color of each section varies with the density of the past tracks.

That is, if the individual past tracks were represented by lines, then as information about these past tracks was stored, the display would become a tangle of lines and be harder to read clearly. With the above configuration, information about past tracks can be displayed in an easy to understand format, without being affected by how much information there is about past tracks.

With the above ship display device, it is preferable if the colors of the sections varies to change from one color to another as the density of the past tracks increases.

This affords an intuitive understanding of the trend in track density.

With the above ship display device, it is preferable if the display component displays a section in which one or more of the past tracks are present and a section in which no past tracks are present in different display modes.

Consequently, it is easy to tell the difference between areas with and without past tracks.

With the above ship display device, it is preferable if the weighting of the density of the past tracks varies according to the size of the ships.

Consequently, the weighting by which ship tracks are evaluated for track density varies according to how large a ship is, so a track density distribution that conforms to the intuitive image in the user's mind can be displayed.

With the above ship display device, it is preferable if the size of the geographical range of the effect that the past tracks of the ships have on the track density distribution varies according to the size of the ships.

Consequently, the geographical range of the effect that the tracks of the ships have on the track density varies according to how large the ships are, so a track density distribution that conforms to the intuitive image in the user's mind can be displayed.

With the above ship display device, it is preferable if the display component displays the past tracks of at least one of a host ship and another ship within a most recent period of time with lines.

Consequently, the display is given in an organized form, the user can easily understand both the overall trend of past tracks and recent specific past tracks of the host ship and another ship.

With the above ship display device, it is preferable if the display component displays the track density distribution for just another ship out of the ships.

Consequently, if the user wishes to know the track density distribution for just another ship out of the ships, that information can be easily ascertained.

With the above ship display device, it is preferable if the display component displays the past track for just a host ship out of the ships with a line.

Consequently, it is easy to understand the relation between the past track of the host ship and the past track of the other ship.

With the above ship display device, it is preferable if the display component displays the track density distribution for just ships of at least a specific size out of the ships.

Consequently, it is easy to ascertain the trend for the routes of larger ships, such as large tankers and merchant vessels.

With the above ship display device, it is preferable if the display component displays the track density distribution for just ships smaller than a specific size out of the ships.

Consequently, a fishing boat can make use of the fact that there is a relatively large number of smaller vessels to find fishing sites where fishing vessels are coming and going.

With the above ship display device, it is preferable if the display component displays the track density distribution for just a host ship out of the ships.

Consequently, it is easy to analyze the navigation situation for the host ship, for example.

### BRIEF DESCRIPTION OF THE DRAWINGS

Referring now to the attached drawings which form a part of this original disclosure:

FIG. 1 is a block diagram of the configuration of a ship device network system comprising the ship display device pertaining to an embodiment of the present invention;

FIG. 2 is a front view that shows an overview of the ship display device;

FIG. 3 shows a plotter image that can be displayed by the ship display device;

FIG. 4 shows an example of a plotter image in which the density distribution of past tracks is displayed as a grid;

FIG. 5 shows a comparative example in which past tracks are displayed directly by lines;

FIG. 6 shows an example in which the past tracks of the host ship and another ship within a most recent period of time are displayed with lines, and older past tracks are displayed in the form of a track density distribution; and

FIGS. 7A, 7B, and 7C illustrate a modification example in which density distribution related to the probability of fish detection is displayed.

### DETAILED DESCRIPTION OF EMBODIMENTS

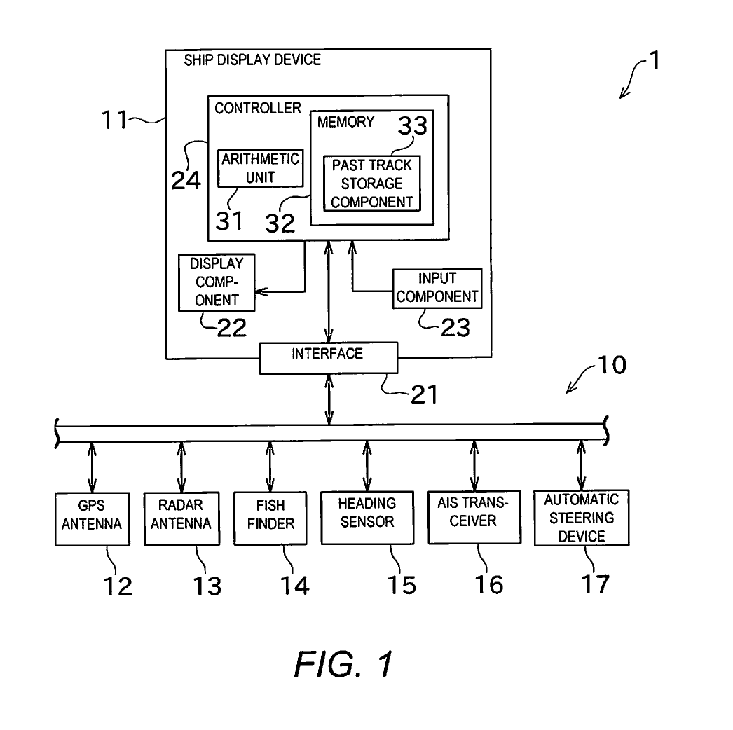

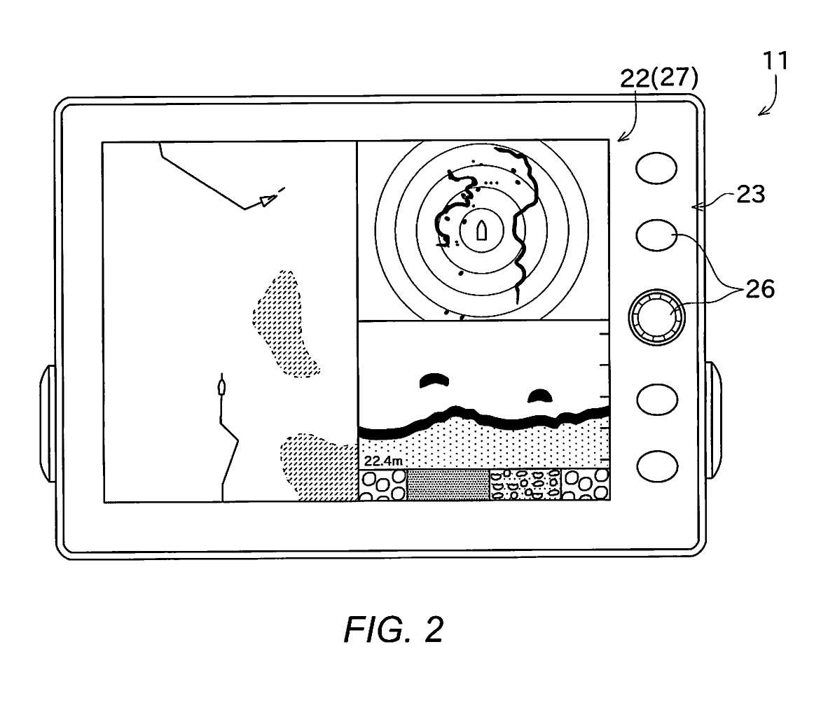

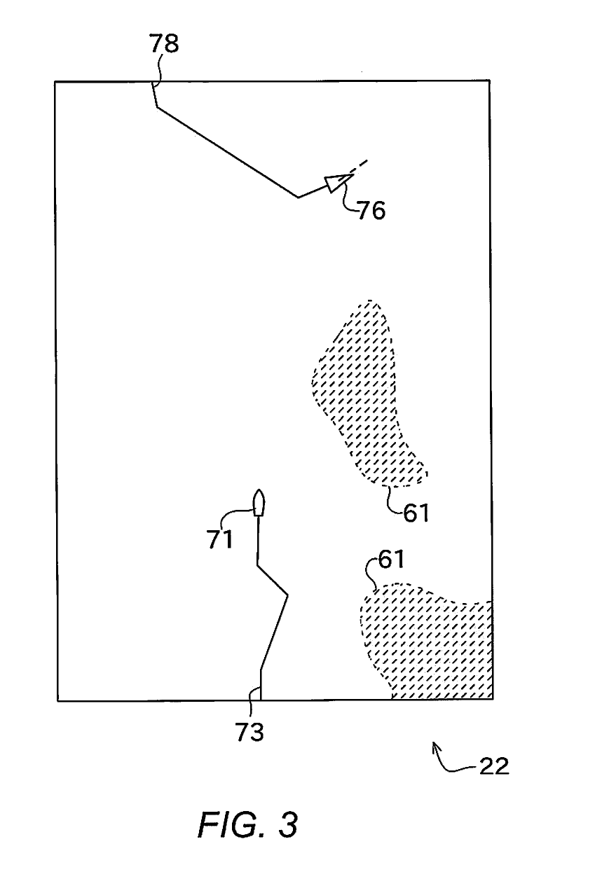

Next, a selected embodiment of the present invention will be described through reference to the drawings. FIG. 1 is a block diagram of the configuration of a ship device network system 1 comprising the ship display device 11 pertaining to an embodiment of the present invention. FIG. 2 is a front view that shows an overview of the ship display device 11. FIG. 3 shows a plotter image that can be displayed by the ship display device 11.

The ship device network system 1 is made up of a plurality of ship devices connected to a network 10. These ship devices can exchange sensed information and the like through the network 10. The standard for the network 10 can be, for example, a LAN (local area network) or a CAN (controller area network).

As shown in FIG. 1, the ship device network system 1 in this embodiment comprises the ship display device 11, a GPS antenna (GNSS sensor) 12, a radar antenna 13, a fish finder 14, a heading sensor 15, an AIS transceiver 16, and an automatic steering device 17.

The ship display device 11 produces and displays various kinds of video on the basis of information sensed by other ship devices, and can perform various kinds of processing in response to user input.

The specific configuration of the ship display device 11 will now be described. The ship display device 11 comprises an interface 21, a display component 22, an input component 23, and a controller 24.

The interface 21 is configured as a network adapter or the like, for example. The ship display device 11 can send and receive various kinds of information through the interface 21 to and from the other devices that constitute the ship device network system 1.

The display component 22 is configured by a liquid crystal display or the like, and can display various kinds of sensor image, setting screens, and so forth on a display screen in response to user input. A sensor image is an image that graphically represents information acquired by a sensor device. Examples of sensor images include a plotter image showing a sea chart of the area around the host ship, a radar image showing radar echoes around the host ship, and fish images from the fish finder.

FIG. 2 illustrates an example in which the display component 22 is divided into three parts, with the left side showing a plotter image, the upper-right side a radar image, and the lower-right side a fish finder image. Thus, the display component 22 can display different sensor images simultaneously on the same screen.

As shown in FIG. 2, the input component 23 includes various hardware keys 26 disposed near the display screen of the display component 22, and a touch panel 27 disposed on the display screen of the display component 22. The user can input various instructions to the ship display device 11 by touching the touch panel 27 on the screen or operating the hardware keys 26.

The controller 24 shown in FIG. 1 comprises a CPU or other such arithmetic unit 31, and a ROM, RAM, or other such memory 32. This hardware works together with a display control program stored in the memory 32 to control the display on the display component 22.

More specifically, the controller 24 of the ship display device 11 produces the various sensor images as needed on the basis of information received from other ship devices and what is stored in the memory 32, and displays the image on the display component 22.

The memory 32 has a storage area (a past track storage component 33) for storing u past tracks that show the paths that the host ship and other ships have traversed in the past. Processing related to past tracks will be discussed in detail below.

The GPS antenna 12 receives a positioning signal from a GPS satellite (a GNSS satellite), and outputs the signal through the network 10 to the ship display device 11, etc. The controller 24 of the ship display device 11 finds the position of the host ship (more precisely, the position of the GPS antenna) on the basis of this positioning signal, and stores it in the memory 32 of the controller 24. The configuration may be such that computation for finding a position from a positioning signal is performed on the GPS antenna 12 side, and the GPS antenna 12 outputs the position of the host ship to the ship display device 11.

The ship display device 11 can function as a navigation device on the basis of the position of the host ship found by GPS positioning and sea chart information (map information) stored by the ship display device 11 itself. More specifically, the ship display device 11 can superpose the display of the host ship's position over a sea chart on the display component 22 on the basis of the acquired host ship position and the stored sea chart information (plotter image). Also, the ship display device 11 can make use of the position of the host ship, which changes over time, to find the over-the-ground speed or to find the track of the host ship, and displays the result on the display component 22.

The radar antenna 13 is part of a radar (sensor), and is used to transmit microwaves and receive reflected waves from a target. These reflected waves undergo suitable signal processing, after which they are outputted to the ship display device 11. The ship display device 11 produces a radar image on the basis of these reflected waves. More specifically, the controller 24 of the ship display device 11 finds the distance to a target from the time it takes to receive a reflected microwave after sending it out. The controller 24 also finds the direction in which the target is located on the basis of the direction in which the microwaves were transmitted. The controller 24 can thus produce a radar image and display it on the display component 22.

The ship display device 11 makes use of the information obtained from the radar antenna 13 to provide a TT (target tracking) function. Since this TT function is common knowledge, it will not be described in detail here, but in short, the position of the target is automatically sensed on the basis of the radar echoes obtained from the radar antenna 13, and movement of this target over time is tracked to estimate the speed vector. The controller 24 of the ship display device 11 can superpose the target being tracked (such as another ship) over a plotter image, radar image, or other such sensor image in the display on the display component 22.

The fish finder 14 is made up of a vibrator and an analyzer. The vibrator is installed on the hull, etc., generates ultrasonic waves at a specific timing (such as at specific clock times) in the direction of straight down in the sea, and also receives waves reflected back from the sea bottom or a school of fish. The analyzer analyzes the received reflected waves to produce data indicating a school of fish, etc., and outputs the result to the ship display device 11. The controller 24 of the ship display device 11 produces a fish finding image on the basis of the received data, and displays this image on the display component 22.

The heading sensor 15 is configured to sense the heading of the host ship (the direction in which the prow is facing) as a relative orientation based on the land. In general, a ship advances in the direction of its heading. Therefore, the heading sensor 15 could also be said to sense the orientation of the forward direction of the ship. The heading sensor 15 can be a magnetic orientation sensor, a GPS compass, or the like.

The AIS transceiver 16 can receive AIS information outputted by an AIS (automatic identification system) installed on another ship. This AIS signal includes identification information for identifying this other ship, as well as the position, speed, course, size (overall length, width), and other such information. The AIS transceiver 16 outputs the AIS information received from the other ship to the ship display device 11. The controller 24 of the ship display device 11 can superpose an AIS symbol indicating the other ship over the various sensor images in the display. The AIS transceiver 16 is also designed to be able to transmit information related to the host ship (the same information as that received from other ships) as an AIS signal to other ships.

The automatic steering device 17 is used for automatic control of the rudder so that the host ship will move along the set navigation route. More specifically, the automatic steering device 17 finds how much the heading of the host ship should be changed on the basis of the heading acquired from the heading sensor 15 and the navigation route acquired from the ship display device 11. The automatic steering device 17 then changes the rudder angle according to the value thus found, and matches the course of the host ship to the navigation route.

The ship device network system 1 in this embodiment is configured as above. The ship devices that constitute the ship device network system 1 are optional, and the configuration may be such that ship devices other than those described above are connected, or such that a plurality of the same type of ship devices are connected. Also, processing of the data acquired by the ship devices may be performed by said ship devices, or may be performed by the controller 24 of the ship display device 11.

Next, a display example of a plotter image, which is one of the sensor images that can be displayed with the ship display device 11, will be described through reference to FIG. 3.

The display component 22 of the ship display device 11 can graphically display the position of the host ship on a sea chart on the basis of information about the current position of the ship obtained from the GPS antenna 12.

FIG. 3 shows an example of what is displayed in the plotter image. In FIG. 3, just the left half of the display screen of the display component 22 shown in FIG. 2 is shown. As shown in FIG. 3, the sea chart information stored ahead of time in the ship display device 11 is displayed on the display component 22. This sea chart information includes the shapes of coastlines and shallows, the water depth, the locations of lighthouses and navigation buoys, and so forth, which are electronically recorded. In the example in FIG. 3, shallows 61 are displayed as a plotter image.

On the display component 22, the current position and heading of the host ship are displayed as a host ship icon 71 that is superposed over the above-mentioned sea chart information, and a past track 73 indicating the path traveled by the host ship up to now is also displayed. Also, the position and heading of another ship obtained by the AIS transceiver 16 are displayed on the display component 22 as an other ship icon 76 (serving as the above-mentioned AIS symbol). The displayed position, orientation, and so forth of the host ship icon 71 and the other ship icon 76 are updated in real time if there is a change in the status of the host ship, the other ship, etc.

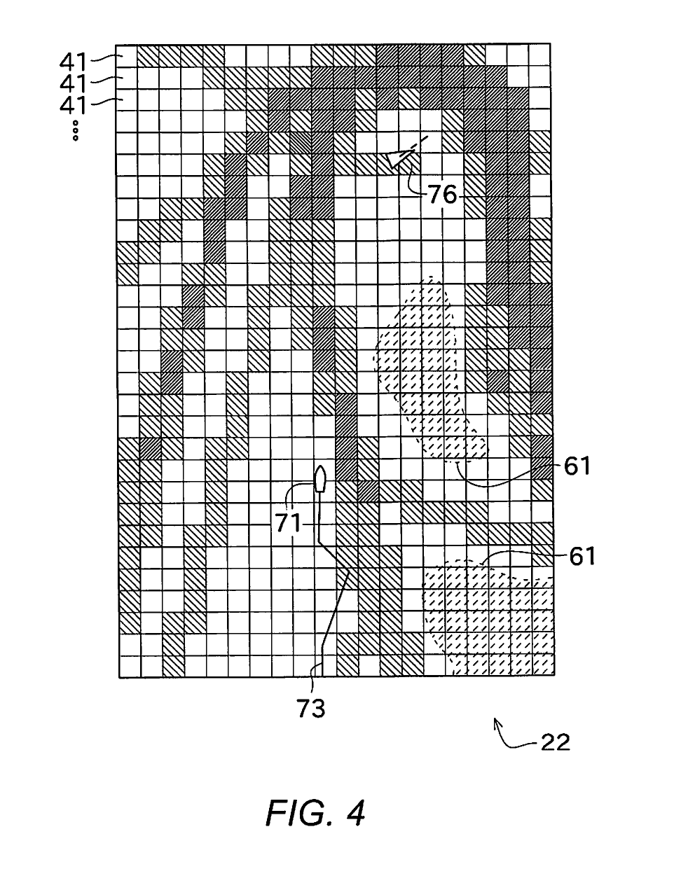

Furthermore, the ship display device 11 is designed so that when a certain operation is performed on the input component 23, the track density distribution of other ships, obtained by collating all the past tracks indicating the paths traveled by other ships in the past, can be graphically displayed as shown in FIG. 4, superposed over the sea chart information (density distribution display mode).

This track density distribution is realized by dividing up the area corresponding to the display range of the plotter screen at regular intervals into north, east, south, and west, counting the number of times the past tracks of other ships have gone through the square sections 41 thus formed, and displaying these sections 41 in colors that correspond to the count values. The counting of tracks and other such processing is performed by the arithmetic unit 31 had by the controller 24 of the ship display device 11.

The past tracks of other ships can be obtained by referring to what is stored in the past track storage component 33 of the memory 32. More specifically, transitions in the position of the host ship obtained by repeated GPS positioning at specific time intervals, and transitions in the positions of other ships obtained by repeatedly analyzing AIS information at specific time intervals can be stored in the past track storage component 33. “Transitions in the position of the host ship” means the past tracks of the host ship, and “transitions in the positions of other ships” means the past tracks of other ships.

FIG. 4 shows a case in which north is always displayed at the top (north up), and in this case the area is divided into north, east, south, and west, and it is preferable if the grid is not inclined. From the same standpoint, if the heading of the host ship is always displayed at the top (heading up), it is preferable to divide the area in directions that are parallel and perpendicular to the heading of the host ship.

In the example in FIG. 4, the sections 41 in which there are no past tracks of other ships are display in white, the sections 41 in which there are at least one but no more than two past tracks of other ships are displayed in yellow, and the sections 41 in which there are three or more past tracks of other ships are displayed in red (because the drawings are in black and white, the different colors of the sections in FIG. 4 are represented by different types of hatching. The user can utilize the density distribution displayed as above as information for improving safety in the navigation of the host ship, or for selecting a fishing site. Also, since the display mode (and more specifically, the color) is different between sections in which there is one or more past tracks and sections in which there are no past tracks, the user can easily tell areas with past tracks apart from those without any.

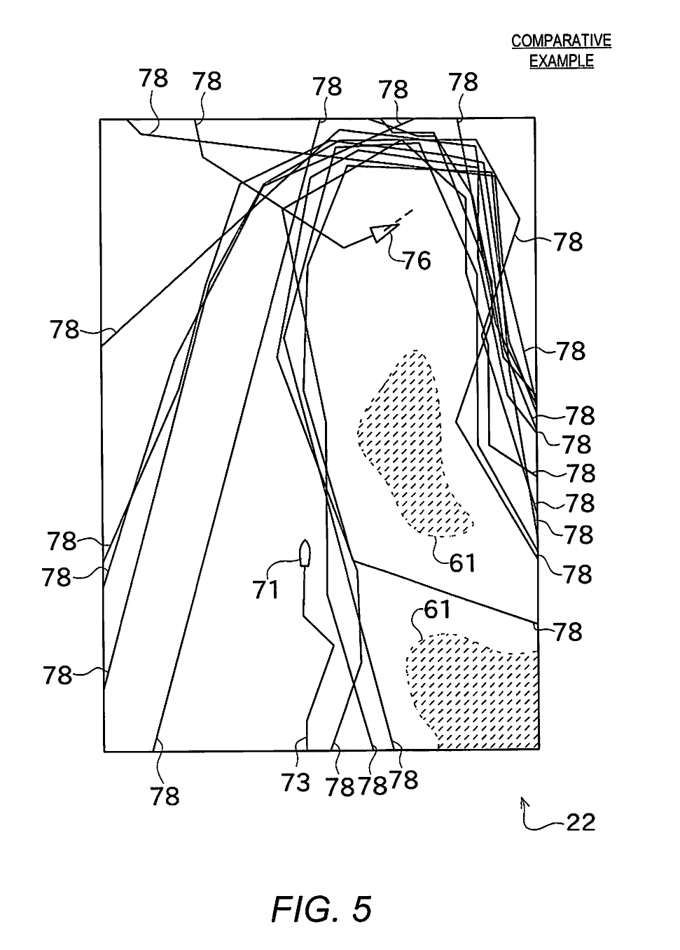

As shown in the reference example in FIG. 5, a configuration in which past tracks 78 of other ships are displayed directly with lines also allows the user to ascertain how areas are tending to mix together. However, in a congested sea area, for example, numerous lines indicating past tracks 78 are displayed mixed together, and this can make the display harder to read. If the density is displayed using sections 41 of a certain size as units as in this embodiment, then an organized displayed can be obtained even where tracks are mixed together.

The colors of the sections 41 can also be varied so as to gradually change from one color to the next, according to the number of times other ships have passed through a section (which essentially indicates the density of the past tracks). For instance, if there is only one past track of another ship, this may be displayed in pale yellow, if there are two past tracks, it may be displayed in a yellow that is somewhat brighter than in the case in which there is only one past track, and so forth. This affords an intuitive understanding of the tendency for track density.

In calculating the density of the past tracks of other ships, it is also possible to vary the weighting according to the size of these ships. Specifically, the configuration is such that the past track storage component 33 stores the past tracks of ships (the host ship and other ships), and can also store the size of these ships. The size of other ships out of the ships can be found on the basis of AIS information received by the AIS transceiver 16. The size of the host ship can be obtained by referring to the host ship size setting that is set as AIS information from the host ship to other ships.

In calculating the density distribution related to the past tracks of other ships, if the overall length of another ship is at least a specific value, some sections 41 are counted twice even though that ship has passed along that past track only once. The above method is just one example, and the specific way in which weighting is performed can be modified as needed. Thus varying the weighting with which the track of a ship is evaluated as track density according to the size of the ship allows the display to reflect the image had by the ship operator for large ships and small ships, and allows the track density distribution to be displayed in a way that is intuitive for the user.

Also, in calculating the density of the past tracks of other ships, it is possible to vary the size of the geographical range of the effect that the past tracks have on the track density distribution according to the size of the ships. As a specific example, if the overall length of another ship is less than a specific value in calculating the density related to the past tracks of another ship, if a past track of that ship has passed through a certain section 41, it is counted one time, but if the overall length of the other ship is at least the specific value, it is conceivable that it will be counted one time if the past track has passed through at least one of this section 41 and any of the eight sections 41 that are vertically, laterally, or diagonally adjacent to this section 41. The above method is just an example, and the size of the geographical range of the effect that the past tracks have on the density distribution can be modified as needed. This again affords the display of a track density distribution that conforms to the intuitive image in the user's mind.

In FIG. 4, the past track 73 of the host ship and the host ship icon 71 indicating the current position of the host ship are displayed in a form in which they overlap the track density distribution obtained by collating the past tracks for other ships. Thus displaying the past tracks of other ships in the form of a density distribution, and displaying the past track 73 of the host ship directly with a line make it easy for the user to tell the past track 73 of the host ship apart from the past tracks of other ships.

However, if the past track 73 of the host ship is displayed with a line, there is the risk that the lines will become jumbled once there are quite a few of them, just as with the past tracks 78 of the other ships shown in FIG. 5. Therefore, the past tracks of the host ship may be displayed in the form of a density distribution just as with the past tracks of other ships. In other words, the navigation density distribution of ships may be displayed on the display component 22 in a form in which the host ship and other ships are integrated.

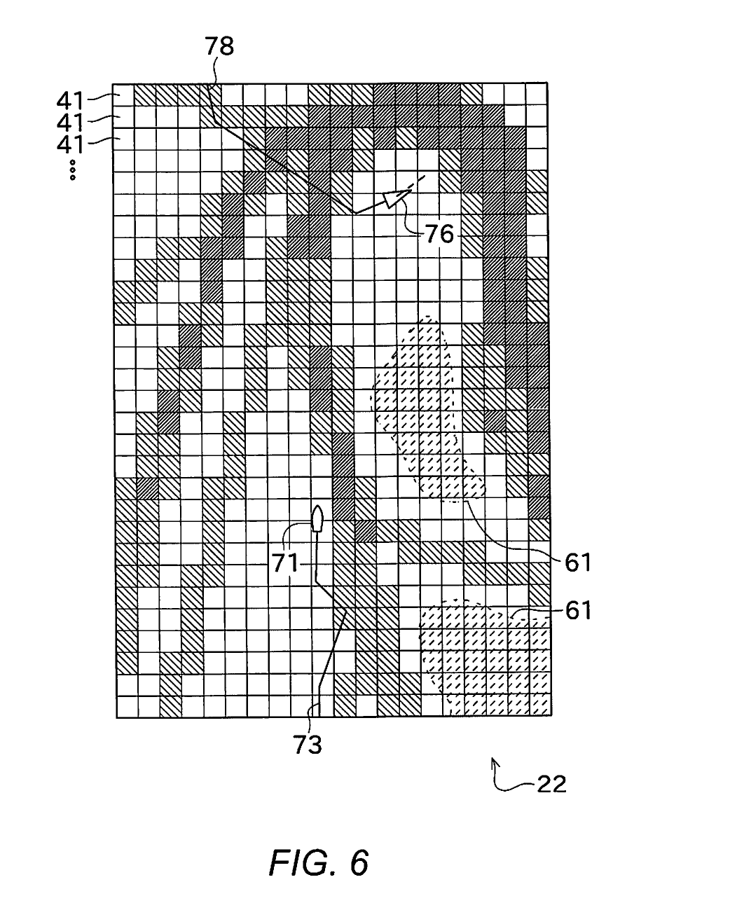

Also, for the past tracks of one of the host ship and other ships, just the ones within a most recent period of time may be displayed with a line, and the older ones may be displayed in the form of a density distribution. FIG. 6 shows an example in which the most recent past tracks are displayed with a line, and the remaining past tracks are displayed as a density distribution. In this case, the user can easily comprehend both the overall tendency of the past tracks and the specific recent past tracks of the host ship and the other ships from an organized display.

In the display in FIG. 6, for example, the past tracks within a certain length of time in the past can be displayed with a line, and earlier past tracks can be displayed with a density distribution. Also, past tracks produced when the ships currently displayed as the host ship icon 71 and the other ship icon 76 move within the display screen are displayed by a line for the most recent past tracks, and if the line display goes outside the screen, thereafter that past track may be displayed in the form of a density distribution.

In the example in FIG. 6, the track density distribution is calculated in a form in which the (most recent) past tracks displayed with a line are excluded. However, instead of this, the configuration can be such that the past tracks within the most recent period of time are displayed with a line, and the density distribution of the past tracks over the entire period of time including the most recent interval is displayed.

The ship display device 11 in this embodiment is able to perform filtering under various conditions for the display of navigation density distribution on a grid. For instance, if the navigation density distribution is displayed for just other ships, it will be easier to notice routes that are not traveled by the host ship but are often traveled by other ships. Also, if the track density distribution is displayed for just the host ship, it will be easier to analyze the navigation situation for the host ship.

Furthermore, if the track density distribution is displayed for just ships of at least a specific size, it will be easier to ascertain the trend in the routes of larger ships, such as large tankers and merchant vessels. If the host ship is a small ship, it is generally deemed unwise for it to go too close to large ships that have different motion characteristics and also produce a large wake, so the above information is useful. Meanwhile, if the track density distribution is displayed for just ships that are smaller than a specific size, a fishing boat can make use of the fact that there is a relatively large number of smaller vessels to find fishing sites where fishing vessels are coming and going.

As described above, the ship display device 11 in this embodiment comprises the past track storage component 33 and the display component 22. The past track storage component 33 stores information related to the past tracks of ships. The display component 22 graphically displays the track density distribution, which is the density distribution of past tracks.

Consequently, geographical trends related to the density of ship traffic can be easily grasped on the basis of information about past tracks. As a result, navigational safety is improved, and this feature can be put to good use in selecting fishing sites, for example. Also, since the tracks are displayed in the form of a density distribution, the display does not look complicated to the user.

A preferred embodiment of the present invention was described above, but the above configuration can be modified as follows, for example.

In the track density distribution shown in FIGS. 4 and 6, those sections 41 in which not a single past track has passed may not be displayed. In this case, since superfluous squares (sections) are not displayed, the screen looks less cluttered.

The above configuration can be applied not only to the plotter image shown in FIG. 4, but also to a radar image. More specifically, tracks obtained by tracking a target with the above-mentioned TT function had by the ship display device 11 are stored as tracks of other ships in the past track storage component 33, and the track density distribution of other ships can be produced on the basis of this. Incidentally, the size of another ship can be approximated on the basis of the size of the target displayed on the radar screen.

The method for acquiring past tracks of other ships is not limited to the above-mentioned AIS information and TT function. For example, the configuration can be such that the host ship is equipped with a transceiver (such as a DSB transceiver) capable of exchanging position information with other ships by wireless data communication, and position information acquired from other ships by this transceiver is stored in the past track storage component 33.

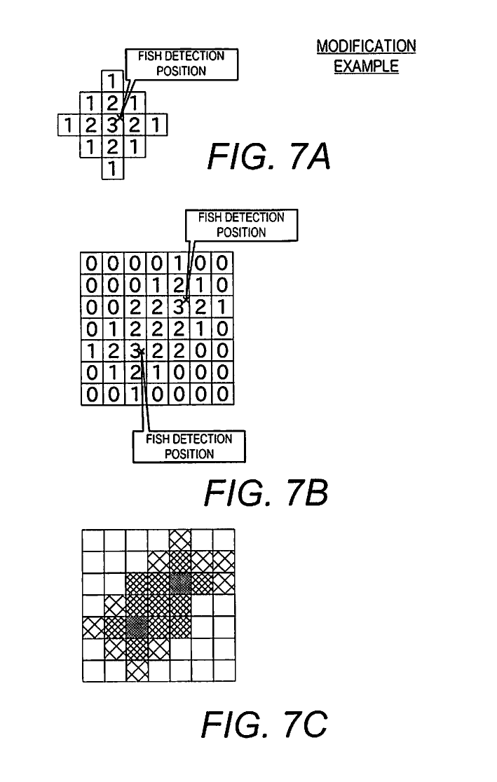

Instead of displaying the track density distribution in a grid, the probability of the presence of fish based on fish detection information obtained by a fish finder may be displayed in a grid. More specifically, the controller 24 of the ship display device 11 stores in the memory 32 the position of the host ship at the point of detection (hereinafter also called the fish detection position) on the basis of a signal that is automatically outputted when the fish finder 14 has detected fish. The area corresponding to the display range on the plotter screen is divided up at regular intervals, and for the fish detection positions that have been stored, numerical values such as those in FIG. 7A (note that the specific method for assigning evaluation values is not limited to what is shown in FIG. 7A, and can be modified as needed) are assigned to sections in which the fish detection positions are included and to nearby sections. If a plurality of fish detection positions are included in a given section, or if there are fish detection positions in sections near to each other, the evaluation values based on these fish detection positions are added up. FIG. 7B shows an example in which the evaluation values based on two fish detection positions are added up. The sections are displayed in color so that the larger is the sum of evaluation values related to the probability of the presence of fish, the more the display changes gradually from one color to another (such as from white to red). Consequently, the fish habitat range automatically becomes visible as shown in FIG. 7C, so this can be put to use as information that is useful for selecting a fishing site. Also, since information related to the probability of the presence of fish is displayed in the form of a density distribution in which each section is a unit, the display will tend to be less complicated even when there are numerous fish detection positions than with a configuration in which a mark (such as a fish icon) is displayed at each fish detection position.

The fish finder 14 is configured so that fish schools, bottom-feeder fish schools, individual fish, and other such detection types can be outputted on the basis of the result of analyzing reflected waves with the analyzer by a known method. This may be utilized so that the display of density distribution related to the probability of the presence of fish is narrowed down from the standpoint of the fish detection type, or the color of the display may be changed for each fish detection type. Also, the configuration may be such that when fish detection positions are stored in the memory 32, information about the season, time of day, water temperature, water depth, age in months, tides, and so forth can be stored at the same time, and a density distribution related to the probability of the presence of fish can be displayed in a form that is narrowed down from these standpoints. Here, the fish detection information can be achieved by a sonar instead of the fish finder 14.

The configuration may be such that information about past tracks and fish detection positions can be exchanged with other ships by wireless communication or another such means, and the density distribution can be displayed in a form in which the data are integrated with other ships.

Not just information related to past tracks and the detection of fish, but the distribution of water temperature, water depth, and bottom quality information can also be displayed in a grid.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a selected embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A ship display device comprising:
a past track storage component configured to store information related to past tracks of ships; and
a display component configured to graphically display a track density distribution, which is a density distribution of the past tracks.

2. The ship display device according to claim 1, wherein
the display component is configured to display the track density distribution with a grid divided up in regular intervals, and
the color of each section varies with the density of the past tracks.

3. The ship display device according to claim 2, wherein
the colors of the sections varies to change from one color to another as the density of the past tracks increases.

4. The ship display device according to claim 2, wherein
the display component is configured to display a section in which one or more of the past tracks are present and a section in which no past tracks are present in different display modes.

5. The ship display device according to claim 3, wherein
the display component is configured to display a section in which one or more of the past tracks are present and a section in which no past tracks are present in different display modes.

6. The ship display device according to claim 1, wherein
the weighting of the density of the past tracks varies according to the size of the ships.

7. The ship display device according to claim 2, wherein
the weighting of the density of the past tracks varies according to the size of the ships.

8. The ship display device according to claim 1, wherein
the size of the geographical range of the effect that the past tracks of the ships have on the track density distribution varies according to the size of the ships.

9. The ship display device according to claim 2, wherein
the size of the geographical range of the effect that the past tracks of the ships have on the track density distribution varies according to the size of the ships.

10. The ship display device according to claim 1, wherein
the display component is configured to display the past tracks of at least one of a host ship and another ship within a most recent period of time with lines.

11. The ship display device according to claim 2, wherein
the display component is configured to display the past tracks of at least one of a host ship and another ship within a most recent period of time with lines.

12. The ship display device according to claim 1, wherein
the display component is configured to display the track density distribution for just another ship out of the ships.

13. The ship display device according to claim 2, wherein
the display component is configured to display the track density distribution for just another ship out of the ships.

14. The ship display device according to claim 12, wherein
the display component is configured to display the past track for just a host ship out of the ships with a line.

15. The ship display device according to claim 13, wherein
the display component is configured to display the past track for just a host ship out of the ships with a line.

16. The ship display device according to claim 1, wherein
the display component is configured to display the track density distribution for just ships of at least a specific size out of the ships.

17. The ship display device according to claim 1, wherein
the display component is configured to display the track density distribution for just ships smaller than a specific size out of the ships.

18. The ship display device according to claim 1, wherein
the display component is configured to display the track density distribution for just a host ship out of the ships.

19. The ship display device according to claim 2, wherein
the display component is configured to display the track density distribution for just a host ship out of the ships.
